(19) United States
(12) Patent Application Publication
(10) Pub. No.: US 2023/0090277 A1
(43) Pub. Date: Mar. 23, 2023

(54) DATA STORAGE DEVICE REDEPLOYMENT

(71) Applicant: Seagate Technology LLC, Fremont, CA (US)

(72) Inventors: Lihong Zhang, Singapore (SG); Xiong Liu, Singapore (SG); Hong Geok Toh, Singapore (SG)

(73) Assignee: Seagate Technology LLC, Fremont, CA (US)

(21) Appl. No.: 17/479,239

(22) Filed: Sep. 20, 2021

(51) Int. Cl. G06F 3/06

(52) U.S. Cl. CPC G06F 3/0647; G06F 3/0604; G06F 3/0685; G06F 3/0689

(57) ABSTRACT

Systems and methods are disclosed for data storage redeployment. For example, a controller of a data storage array can implement a process to determine when, or if, to redeploy a data storage device from a first data storage usage or tier having a first performance requirement to a second data storage usage or tier having a second performance requirement. In some embodiments, the first data storage tier performance requirement is for hot-data storage, and the second data storage tier performance requirement is for cold-data storage. Various criterion (e.g., a data storage device performance metric) threshold, such as a workload (e.g., LBAs written, LBAs read, or both) of the data storage device or bit error rate (BER), may be utilized in a redeployment determination.

### SUMMARY

In certain embodiments, an apparatus may comprise a first controller configured to manage an array of data storage devices and determine when to redeploy a specific data storage device of the array from a first storage tier having a first performance requirement to a second storage tier having a second performance requirement. The controller may also be configured to initiate a redeployment of the specific data storage device from the first storage tier to the second storage tier based on the determination.

In certain embodiments, a method may include determining, via a first controller, when to redeploy a data storage device, of an array of data storage devices, from a first storage tier having a first performance requirement to a second storage tier having a second performance requirement, and initiating a redeployment of the data storage device from the first storage tier to the second storage tier based on the determination.

In certain embodiments, a memory device can include instructions that, when executed by a processing device, cause the processing device to perform a method comprising determining when to redeploy a data storage device, of an array of data storage devices, from a first storage tier having a first performance requirement to a second storage tier having a second performance requirement, and initiating a redeployment of the data storage device from the from the first storage tier to the second storage tier based on the determination.

### BRIEF DESCRIPTION OF THE DRAWINGS

FIG. 1 is a diagram of a system for data storage device redeployment, in accordance with certain embodiments of the present disclosure;

FIG. 2 is a flowchart of a method of data storage device redeployment, in accordance with certain embodiments of the present disclosure; and

FIG. 3 is a flowchart of a method of data storage device redeployment, in accordance with certain embodiments of the present disclosure.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure.

In accordance with various embodiments, the methods and functions described herein may be implemented as one or more software programs running on a computer processor or controller. Dedicated hardware implementations including, but not limited to, application specific integrated circuits (ASIC), programmable logic arrays, system-on-chip (SoC), and other hardware devices can likewise be constructed to implement the circuits, functions, processes, and methods described herein. Methods and functions may be performed by modules or engines, both of which may include one or more physical components of a computing device (e.g., logic, circuits, processors, controllers, etc.) configured to perform a particular task or job, or may include instructions that, when executed, can cause a processor or control system to perform a particular task or job, or may be any combination thereof. Further, the methods described herein may be implemented as a computer readable storage medium or memory device including instructions that, when executed, cause a processor to perform the methods.

While some of the discussion herein is provided with respect to hard disc drives and solid state drives, one skilled in the art will recognize that the technologies and solutions disclosed are applicable to any type of data storage device. For example, any type of data storage devices that can be utilized for different storage tiers that have differing storage performance requirements can be utilized to construct a multi-tiered data storage system or data storage array.

Data centers need many data storage devices (DSDs), such as hard disc drives (HDDs) or solid state drives (SSDs) to support the growth of needed data capacity. However, maximizing a storage life of a DSD to fulfill the worldwide needs of storage capacity is a critical problem. Having a shorter than possible life of a DSD can lead to an increased total cost of ownership (TCO) and an increased maintenance cost, such as from more frequent swapping of DSDs.

Practically, all DSDs will show consistent write and read degradations with an increase of workload, which is a natural process, leading to a decrease in performance. Performance and electronics degradations will stress the DSDs and accelerate their breakdown process and can lead to a shorter usable lifespan and higher power consumption, which, in terms of a data center, negatively effects throughput, cost, and power usage.

The solutions provided herein help solve these problems and others. Generally, as detailed below, systems, devices, or methods may be implemented to smartly redeploy DSDs, such as within a data array or a data center. These solutions can increase a DSD useful life in a data storage array, increase performance of DSDs or systems implementing them, and provide other benefits.

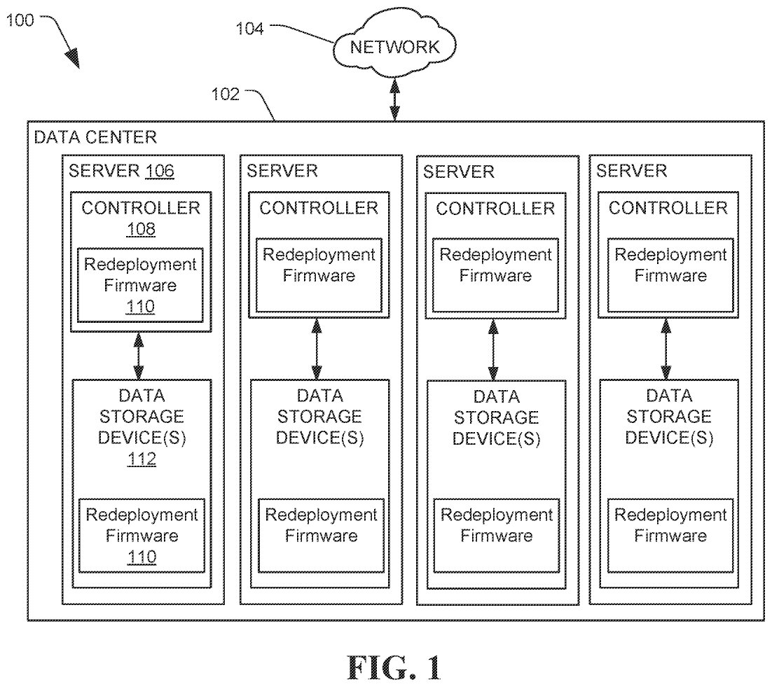

Referring to FIG. 1, a system for data storage device redeployment 100 is provided, in accordance with certain embodiments of the present disclosure. A data center 102 may allow a data storage server 106 to store data and communicate via a network 104. The server 106 can include a controller 108 and one or more data storage devices 112, as well as other components. The one or more data storage devices 112 may be an array of data storage devices, such as a redundant array of independent discs (RAID) or similar. Further, the controller 108, which may be referred to as a server controller or RAID controller, may manage server level operations and data transfers between the network 104 and the one or more data storage devices 112. The data center 102 may have multiple servers with the same or similar configurations.

The controller 108, the one or more data storage devices 112, or both may include a redeployment firmware 110. The firmware may be software code stored in a memory accessible by controller, such as system-on-chip (SoC), where the firmware is executable by a processor of the controller to perform a method.

The redeployment firmware 110 can initiate a redeployment of a DSD from a first usage, such as a first storage level tier used to store hot-data, to a second usage, such as a second storage level tier used to store cold-data based on a criterion threshold or criteria threshold. For example, the firmware 110 can be configured to redeploy HDDs used to store hot-data as HDDs used to store cold-data when a metric of the hot-data HDDs reaches a criterion threshold. The criterion can be determined based on various performance metrics of the respective HDD, such as bit-error-rate (BER), a workload of the HDD, an expected lifespan of the HDD, other factors, or any combination thereof. In some embodiments, such as discussed below, the criteria to determine when to redeploy a DSD may include both a BER and a workload threshold, where either metric hitting its respective threshold will indicate the DSD should be redeployed. DSDs may save metrics in a Self-Monitoring, Analysis, and Reporting Technology (SMART) log during operation. SMART is a monitoring system that can be in a DSD and can report on various attributes of the state of the DSD. In some embodiments herein, for redeployment purposes, a SMART log can include a count of logical block addresses (LBAs) written, a count of LBAs read, and a read error rate that can indicate a BER. Tracking such metrics allows a DSD or server to know details of past operations, or the effects of past operations.

Generally, hot-data represents data with a highest access frequency or are critical files that need to be stored for the fastest and most reliable access. Thus, hot-data should be stored in a data storage tier with a first performance requirement, for example, to provide a higher performance and lowest power consumption. Further, cold-data represents data that does not require fast access, such as archived data and infrequently accessed data. Thus, cold-data should be stored in a data storage tier with a second performance requirement, for example, that provide a lower performance and lower cost than the hot-data storage tier. Also, warm-data can include data that does not need the highest access frequency or is not as critical as hot-data, but needs a quicker access ability than the cold-data. For example, a data center may have a ratio of 70% cold-data storage, 20% warm-data storage, and 10% hot-data storage. Data storage tiers may be one or more DSDs, one or more data storage arrays, or one or more portions of a data storage array. Each DSD in an array of DSDs can be a separate physical device that is separately removable from an array housing structure, such as a server rack shelf.

Redeployment of DSDs from a hot-data tier of storage to a cold-data tier of storage can extend the expected lifespan of the DSD. The criteria of when to perform the redeployment may include an expected lifespan and workload of both the DSDs in the hot-data storage tier and the DSDs in the cold-data storage tier. This will allow a data center to maintain the highest performance for hot-data DSDs while maximizing the life of all DSDs and total storage capacity.

Redeployment can allow a server owner (e.g., a data center or other entity) to better fulfill the requirements for all storage types (hot-data, warm-data, and cold-data) while keeping the total cost of ownership (TCO) to a minimum by redeploying physical hot-data storage devices as physical cold data storage devices. Redeployment can be based on the overall workload of a hot-data DSD. In some embodiments, a server owner, maintenance person, or other system can program the redeployment criterion or criteria and what the thresholds may be, such as based on a total workload threshold, an error rate threshold, or other thresholds (such as an interval of time, a reallocated sectors count that is a count of sectors that have been remapped on a data storage medium such as in a HDD or SSD, or a load cycle count that is a count of actuator motions from a ramp to a disc (or back to the ramp, or both) in an HDD). Such criteria and thresholds may also be set during manufacturing of the DSD or server. For example, a hot-data HDD's workload may be 500 terabytes (TB)/year of data usage (e.g., write operations, read operations, internal data operations, or a combination thereof) with a typical five (5) years of expected life (which may align to a warranty period), giving a total expected workload capability of 2,500 TB. If a cold-storage target workload is 100 TB/year with an expected lifespan often (10) years, giving a total expected workload capability of 1,000 TB. A redeployment point may be set such that when the hot-date HDD reaches 1,500 TB of workload usage (which may be the difference between the expected lifespans of the hot-data and the cold data; e.g., 2,500 TB−1,000 TB=1,500 TB), the HDD is designated for redeployment. Such an embodiment, which uses an analysis of an expected lifespan and workload to determine when to switch a hot-data DSD to a cold-data DSD, could utilize a DSD for a hot-data storage tier without sacrificing any, or minimally, of the cold-data expected lifespan.

In some embodiments, the DSD may notify a cloud management system, such as server controller 108, when the DSD reaches the redeployment threshold and the server controller 108, in conjunction with redeployment firmware 110, may manage the redeployment process. Cloud management system may also store a SMART log to track redeployment metrics, or receive the SMART log or redeployment metrics from the DSD, and can trigger a redeployment without communication from a DSD. In an array of DSDs, each physical DSD may track its redeployment metrics separately from the other DSDs.

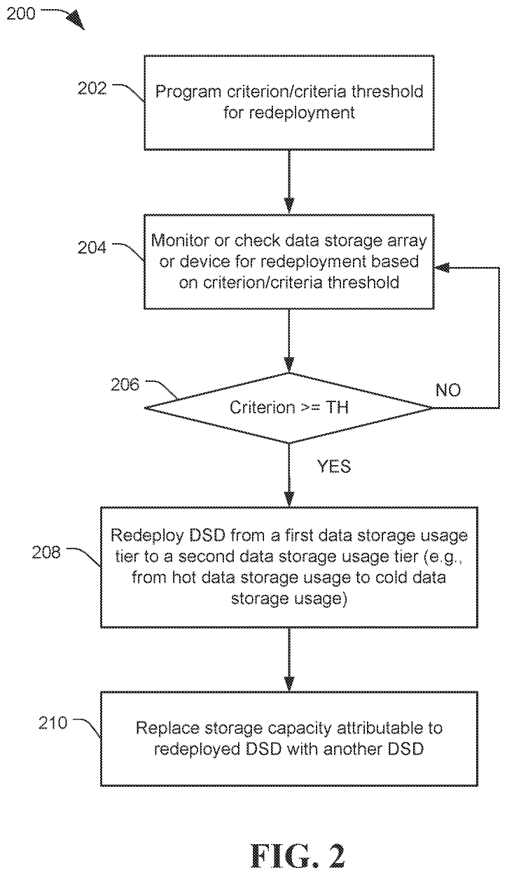

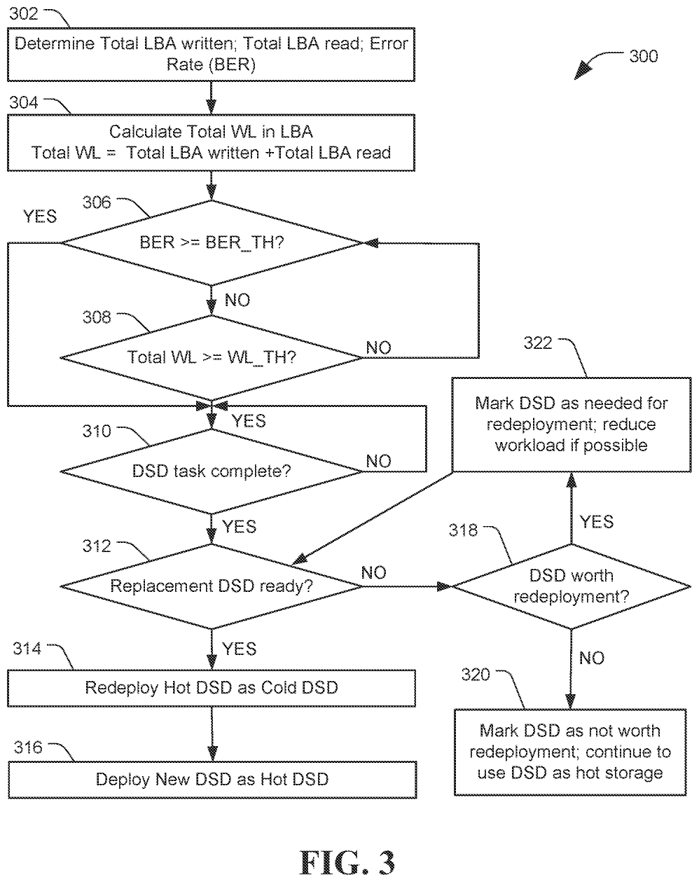

The controller 108, the data storage device(s) 112, or both may perform the redeployment analysis process, including monitoring the metrics, based on a predefined time interval during operation, at each power on stage, by another trigger, or any combination thereof. The DSD 112, and each DSD within an array, may include a data storage controller to manage operations of the DSD, including redeployment processes, and a communication interface to communicate with controller 108. In some embodiments, the controller 108 and the DSD 112's data storage controller are physically separate controllers (e.g., different SoCs or ASICs in different housings and the DSD is removable from a connection with the controller 108), and they each may manage separate redeployment processes or may manage a combined redeployment process in conjunction with each other. Example redeployment processes are provided in FIG. 2 and FIG. 3.

The metrics and thresholds used for a redeployment process can be programmable by a server operator. A server or data center can also choose whether or not to redeploy their hot-storage DSDs when the hot-storage DSDs triggers any of the redeployment criteria or to do another action, such as just provide a notification. A server operator can also choose to extend the operating period of a hot-storage DSD even after the hot-storage DSD triggers a redeployment criterion. Redeployment can also be based on the availability of available hot-data enabled DSDs, or DSD supply, and the overall deployment ratio of hot-data storage and cold-data storage.

With the embodiments to redeploy DSDs provide herein, servers and data centers may maintain better performance and lower power consumption, as well as providing a lower TCO. Further, if one uses new drives as hot-data storage, the servers and data centers will have even better results due to the new drives typically having better BER and less wear, resulting in better throughput and less power consumption. Further, servers and data centers may gain more capacity from their DSDs, since less drives reach their expected end of life as quickly. Also, servers and data centers may reduce the maintenance cost since there may be less failures of DSDs. All of these benefits can lead to a significant reduction in TCO.

Referring to FIG. 2, a flowchart of a method of data storage device redeployment is shown and generally designated 200, in accordance with certain embodiments of the present disclosure. The DSD redeployment process 200 may be implemented by the server 106, such as via the controller 108, the data storage device 112, or a combination thereof. The controller 108 or a data storage controller within the DSD 112 may execute the firmware 110 to implement process 200 or variations thereof.

In some embodiments, process 200 may include programming a criterion threshold or criteria thresholds utilized in a DSD redeployment process, at 202. The programming may be done in a manufacturing facility, during an installation process of a DSD in a server, during use of a server in the field, at another time, or any combination thereof. For example, a cloud management system administrator can determine redeployment policies based on the forecast of data growth rate, ratio of hot-data storage DSDs versus cold-data storage DSDs, DSD specifications, expected cold-data storage workload, failure rates, and so on. The cloud management system administrator can program the redeployment policies via applications, firmware, or other software capable of managing them, which would include the ability to select which criterion or criteria is used for triggering a redeployment indicator or action, the threshold for the selected criterion or criteria, and an action to take when the threshold is reached. In some embodiments, the firmware implementing the redeployment process can include a programmable interface, such as an application programming interface (API), to allow the above to be programmed to the firmware, whether the firmware is executed at the controller 108, the data storage device 112, or both.

Once at least one criterion and threshold is implemented, which could be accomplished by merely implementing defaults stored in the firmware, the redeployment procedure may be performed. The redeployment procedure can include monitoring or checking a data storage array or device for redeployment based on a criterion threshold or criteria thresholds, at 204. When a criterion threshold is met, at 206, a DSD redeployment action may be triggered, at 208. In some examples, the criterion can be a BER, a past workload calculation, a length of time, or a combination thereof. Other implementations as discussed herein may also be applied.

In some embodiments, the DSD redeployment action may include redeploying the DSD from a first data storage usage tier to a second data storage usage tier (e.g., from a hot-data storage usage to a cold-data storage usage). The redeployment action may include other actions or may be delayed based on system preferences. In further embodiments, when a hot-data storage device is redeployed as a cold-data storage device, an older or end-of-lifespan cold-data storage device may be replaced. The replacement storage device may be deemed a hot-data storage device in place of the redeployed DSD. Keeping the newest DSDs as hot-data storage can help provide some of the benefits discussed above.

Referring to FIG. 3, a flowchart of a method of data storage device redeployment is shown and generally designated 300, in accordance with certain embodiments of the present disclosure. The DSD redeployment process 300 may be implemented by the server 106, such as via the controller 108, the data storage device 112, or a combination thereof. The controller 108 or a data storage controller within the DSD 112 may execute the firmware 110 to implement process 200 or variations thereof. Process 300 can be a more detailed example of process 200, specifically steps 204, 206, and 208.

In some embodiments, the process 300 can include determining a number of LBAs written, a number of LBAs read, an error rate (e.g., BER), or any combination thereof. For example, a DSD data controller or server management system may retrieve a DSD SMART log based on a predetermined interval; the DSD SMART log may include data indicating a number of LBAs written, a number of LBAs read, and an error rate. The example process 300 can then calculate a workload (WL), such as a total WL in terms of numbers of LBAs processed, at 304. For example, a total WL can equal a total number of LBAs written by a system added to a total number of LBAs read from the system.

The process 300 can determine whether a BER is greater than (or equal to) a BER threshold (BER TH), at 306. When the BER is not greater than the BER threshold, the process 300 can determine whether a total WL is greater than (or equal to) a WL threshold (WL TH), at 308. When the BER is greater than the BER threshold, the process 300 may skip, at 306, determining whether a total WL is greater than (or equal to) a WL threshold, at 308. When the total WL is not greater than (or equal to) the WL threshold, the process 300 may end or continue monitoring the implemented criterion or criteria, at 306 (though the process 300 could also return to other steps, such as 302 or 308). Thus, when the total WL is greater than the WL threshold, at 308, or when the BER is greater than the BER threshold, at 306, the DSD has been determined to be redeployed; the process 300 can also initiate a redeployment action or indicator and proceed with the redeployment process.

Further, when the total WL is greater than the WL threshold, the process 300 may determine whether a task of the DSD is complete, at 310. In some instances, the process 300 may wait to proceed until all tasks, or all critical tasks (which can be determined based on system requirements), at the DSD are complete, as the redeployment action may necessitate a full repurposing of the physical DSD. Once the task(s) is complete, the process 300 can determine whether a replacement DSD is ready, at 312. A replacement DSD may be ready when there is a hot-data storage device available for use by a system implementing process 300.

When a replacement DSD is ready, the used hot-data storage device can be redeployed as a cold-data storage device, at 314. In some embodiments, the process 300 may also include deploying a new DSD as a hot-data storage device, at 316. A new DSD may be a replacement of a DSD in a server system or may be a DSD in the server that had not yet been utilized.

When a replacement DSD is not ready, at 312, the process 300 may determine whether the DSD is worth redeployment, at 318. Such a determination can be made based on a criterion or criteria, such as the criteria discussed above. For example, when a BER is greater than (or equal to) a BER threshold plus an additional amount of BER, the DSD may not be worthwhile to be redeployed. In another example, when a determined WL is greater than (or equal to) a WL threshold plus an additional among of WL, the DSD may not be worthwhile to be redeployed. Also, these two examples may be combined or implemented simultaneously, at 318. The additional amount of BER and the additional amount of WL may be variables set by the system design or programmed to each provide a second respective threshold that indicates whether or not a drive is worthwhile to be deployed. The system design of those thresholds may be based on a TCO analysis or determination. When the DSD is not worth redeployment, the process 300 may indicate or mark the DSD as such and continue to use the DSD as hot-data storage for the expected lifespan of the DSD or until it fails, at 320 When the DSD is worth redeployment, the process 300 may indicate or mark the DSD as needed for redeployment, at 322. In some embodiments, the process 300 may reduce a workload of a DSD marked as needed for redeployment.

A system controller or data storage controller may store an index (e.g., a table) in memory of all DSDs within a system. The index may store data to indicate relative age of each DSD, metrics related to criteria thresholds for each DSD, whether the DSD is marked for replacement or marked as not worthwhile, whether the DSD is hot-data storage or cold-data storage, any other data necessary to implement process 300 or process 200 or any of the other functions described herein, or any combination thereof.

Further, when more than one DSD is marked as needing to be redeployed, at 322, the process 300 can create a redeployment priority ranking of the redeployable DSDs based on their respective criterion values, such as a BER change in a SMART log. For example, some DSDs having more BER loss can have a higher priority for redeployment than DSDs that have a lower BER loss.

A server, such as via controller 108, can decide when to redeploy the DSDs based on their inventory of storage devices. For example, a server can redeploy the hot-data storage DSDs when there is enough new hot-data storage DSDs available as replacement. If a server does not have enough inventory for hot-data storage devices to replace the redeployable DSDs that are intended to become cold-data storage devices, the server can continue using the redeployable DSDs for hot-data storage. When continuing use of such redeployable DSDs for hot-data storage, the process 300 can continue to monitor their metrics, such as workload and BER and record the metrics in a SMART log, at 322. After continued use of these DSDs, they can be reevaluated if they are still worthwhile or not to be redeployed, at 318.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above embodiments can be made, and other embodiments not specifically described herein will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

1. An apparatus comprising:
a data storage controller for a specific data storage device includes a first controller configured to:
manage an array of data storage devices;
determine when to redeploy the specific data storage device of the array from a first storage tier having a first performance requirement to a second storage tier having a second performance requirement; and
initiate a redeployment of the specific data storage device from the first storage tier to the second storage tier based on the determination.

2. The apparatus of claim 1 further comprising the array of data storage devices including multiple different data storage devices, where each data storage device is separately removable from the array.

3. The apparatus of claim 2 further comprising:
a second controller coupled to the array of data storage devices and configured to manage communications and data storage between a network and the array; and
the first controller is configured to notify the second controller when the specific data storage device should be redeployed.

4. The apparatus of claim 1 further comprising the first performance requirement is based on a hot-data storage and the second performance requirement is based on cold-data storage.

5. The apparatus of claim 1 further comprising the determination is based on a performance-related criterion threshold of the specific data storage device.

6. The apparatus of claim 5 further comprising the performance-related criterion threshold is an expected target lifespan of the specific data storage device.

7. The apparatus of claim 5 further comprising the performance related criterion threshold is a determined past workload of the specific data storage device.

8. The apparatus of claim 7 further comprising the workload is determined based on a number of logical block addresses (LBAs) written by the specific data storage device and a number of LBAs read by the specific data storage device.

9. The apparatus of claim 7 further comprising the performance related criterion threshold is a bit error rate (BER) of the specific data storage device.

10. The apparatus of claim 5 further comprising the performance related criterion threshold is programmable.

11. The apparatus of claim 1 comprising the first controller further configured to:
determine when to redeploy the specific storage device based on determining that the specific data storage device meets a redeployment criterion; and
determine not to redeploy the specific data storage device despite the specific data storage device meeting the redeployment criterion.

12. A method comprising:
determining, via a data storage controller of a data storage device in an array of data storage devices, when to redeploy the data storage device from a first storage tier having a first performance requirement to a second storage tier having a second performance requirement; and
initiating, via the data storage controller, a redeployment of the data storage device from being used for data storage at the first storage tier to being used for data storage at the second storage tier based on the determination.

13. The method of claim 12 further comprising:
determining a performance-related criterion threshold of the data storage device; and
initiating the redeployment based on the performance-related criterion threshold.

14. The method of claim 13 further comprising determining the performance-related criterion threshold based on a number of logical block addresses (LBAs) written by the data storage device.

15. The method of claim 13 further comprising determining the performance-related criterion threshold based on a bit error rate (BER) of the data storage device.

16. The method of claim 12 further comprising:
notifying, via the data storage controller and a communications interface, a second controller when the data storage device should be redeployed, the second controller coupled to the array of data storage devices and configured to manage communications and data storage between a network and the array.

17. A memory device including instructions that, when executed by a processing device, cause the processing device to perform a method comprising:
determining, via a data storage controller of a data storage device in an array of data storage devices, when to redeploy the data storage device from a first data storage usage having a first performance requirement to a second data storage usage having a second performance requirement; and
initiating, via the data storage controller, a redeployment of the data storage device from storing data for the first storage usage to storing data for the second storage usage based on the determination.

18. The memory device of claim 17 comprising the method further including:
the determining when to redeploy is based on a performance-related threshold of the data storage device; and
notifying the array's controller when the data storage device should be redeployed.

19. The memory device of claim 18 comprising the method further including monitoring the performance-related threshold of the data storage device after it has been determined to be redeployed.

20. The memory device of claim 19 comprising the method further including:
initiating the redeployment includes determining that the data storage device meets a redeployment criterion;
determining not to redeploy the data storage device despite the data storage device meeting the redeployment criterion.
